(19) United States
(12) Patent Application Publication
(10) Pub. No.: US 2022/0051226 A1
(43) Pub. Date: Feb. 17, 2022

(54) SYSTEMS AND METHODS FOR WIRELESS INDIRECT TRANSACTIONS

(71) Applicant: GERONIMO LIVE, LLC, West Hollywood, CA (US)

(72) Inventors: Neil ANTIN, West Hollywood, CA (US); Steven ANTIN, Los Angeles, CA (US)

(21) Appl. No.: 17/311,768

(22) PCT Filed: May 7, 2020
(86) PCT No.: PCT/US2020/031932

§ 371 Date: Jun. 8, 2021

Related U.S. Application Data
(60) Provisional application No. 62/844,258, filed on May 7, 2019.

(51) Int. Cl. G06Q 20/32; G06Q 20/40; G06Q 30/06

(52) U.S. Cl. CPC G06Q 20/3278; G06Q 30/0633; G06Q 30/0609; G06Q 20/4015

(57) ABSTRACT

A system for indirect transactions between a buyer and a seller, the system comprising: at least one beacon configured to produce at least one signal; an object that is coupled to the beacon; a buyer device configured to be able to issue purchase requests and comprising a detector, wherein the detector is configured to detect the at least one signal and further comprises; a server, wherein the server comprises an entry stored in a memory that associates the object with the signal and with a seller, and an entry stored in a memory that associates the object with purchasing information associated with the object, and is configured to: determine that the seller is associated with the object based on the signal detected by the buyer device; provide purchasing information associated with the object or a copy of the object to the buyer device.

### PRIORITY CLAIM

This application claims priority to and/or the benefit of U.S. provisional patent application Ser. No. 62/844,258 filed May 7, 2019. The foregoing application is incorporated by reference in its entirety as if fully set forth herein.

### FIELD OF THE INVENTION

This invention relates generally to a hardware and software implemented system for facilitating indirect transactions between buyers and sellers.

### SUMMARY

This invention relates generally to a system and method for wireless, indirect transactions, and more particularly to a system enabling a buyer to identify and purchase a good by identifying a specific target good of interest through a method such as a software application. Specific details of certain embodiments of the invention are set forth in the following description and in the figures to provide a thorough understanding of such embodiments. The present invention may have additional embodiments, may be practiced without one or more of the details described for any particular described embodiment, or may have any detail described for one particular embodiment practiced with any other detail described for another embodiment.

As used herein and unless otherwise indicated, the terms “a” and “an” are taken to mean “one,” “at least one,” or “one or more”. Unless otherwise required by context, singular terms used herein shall include pluralities and plural terms shall include the singular.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

With a great breadth of goods to choose from there is an unmet need for consumers to be able to easily identify the goods and services of a manufacturer, distributor, or seller without needing to rely on brand logos. In the present marketplace there are frequently so many offerings that identifying a specific offering that a consumer was interested in can be a time consuming process that may result in locating the wrong offering or a counterfeit one. The present invention solves the information problem between such consumers and sellers. Furthermore, the present invention facilitates transactions between buyers and sellers without requiring a direct interaction between a salesperson and the buyer, which can be beneficial to certain buyers.

In one embodiment, an object, such as an article of clothing, is tagged with a beacon device (a beacon-tag), such as, but not limited to, a signal chip that may be embedded into a tag or the fabric itself that broadcasts a signal which contains information such as information associated with the object, such as a unique identification number. The signal may then be detected by a sensor which may be programed or embedded into an electronic device such as, but not limited to, a mobile phone. A third-party merchant, distributor, manufacturer, or other party can program or upload to a server certain information such as a serial number or other information in a given signal chip, allowing the detector to interpret and display, or fetch from a centralized database, information regarding a product that has an identifier embedded inside of it. In some embodiments, the signal may simply contain an identification number or other identifier, which the mobile device interprets upon receipt and can reroute to a host database for information related to the object. Some embodiments may allow another user, utilizing the detector or a software application, to purchase the item that has been tagged directly from the owner of that specific item, or in other embodiments the system may redirect the user to a manufacturer or distributor from whom they can purchase the same or a similar product, or shop for similar items. In some embodiments, a detected identifier may provide a user that is utilizing a smart phone or other device with display capability with information on the article and a range of sellers or distributors from whom similar or identical items could be purchased. In some embodiments the invention is comprised of a software application that is integrated into the system and allows display of information detected from the embedded identifiers and/or that the identifier redirects the user to.

For example, in one embodiment of the invention a user would activate their mobile device, or a similar user device, which would then actively detect signals in proximity to the user being emitted by beacon-tags coupled to a variety of objects. The device, or software running on the device, would then cross-reference the signals received with an online database that associates each signal with a specific object, where said database may be hosted by a third party. The device would then present the objects associated with the detected signals to the user with information on how to purchase the items. If the user were interested in purchasing a specific object, the user could indicate that through the device, and may then be able to purchase the specific item from the person who was wearing the objects with the beacon-tag, or may be able to order an identical or similar object from the merchant that ordinarily sells such, or from the manufacturer directly, or another party along the distribution chain.

In effect, one feature of the system is that it can allow a merchant or seller to utilize their existing goods as an advertising means and even functionally as a storefront, wherein the goods themselves essentially advertise themselves by broadcasting their signal. The invention may also involve third parties who have purchased the items to tag them on their own, allowing them to sell their possession to buyers through the system.

In some embodiments the user device is a mobile phone, while in others it may be other electronic devices capable of presenting data to the user such as a computer terminal, laptop, or specialized device for the system.

The system may also be programmed to allow a user to make additional selections once they have found an article of interest. For example, a user may have identified a pair of “red shoes” from a person wearing a tagged pair in their vicinity, but the user has wider feet and prefers the shoes in blue. The sellers, or another party, may have the option to allow the user to order the same look and/or style of shoe but, for example, but not limited to, in an alternative color or with special parameters such as, but not limited to, a wider sole, arch supports, or a wider toe. Thus the user can purchase a similar, but not necessarily identical version of the article of interest. The same approach could be taken for goods of different types, with a seller allowing a user to potentially order a shirt or other clothing item in a different size (or with additional options depending on the nature of the item in question) or in the case of non-clothing they may allow other qualities to be changed. Some sellers may also allow bundling, or provide suggestions for complementary items within the system.

The signal being broadcast by the tagging means or beacon-tag may, in some embodiments, be done so periodically or consistently, depending on the needs of the manufacturer and relative power constraints of the electronic device. The signal may contain information about the object it is attached to, may contain an identifier or other means to direct software or a user to additional information, a number such as stock- keeping unit (SKU) associated with one or more sellers, or may contain an identifier that cross-references with one or more entries in a database.

In some embodiments, the manufacturer of the good that the user has indicated an interest in may offer the option to ship the good to the user directly, or provide instructions regarding the nearest storefront (which may be owned by the manufacturer or a third party) where the user could purchase the item. This option may appear in the user interface of the software, or through other means. Some variants may allow a user to program a passive sensor functionality, such that their mobile device will passively check any signals it receives from the beacons and notify the user if it detects a signal that meets a certain criteria; such as a specific price, an item being listed as on-sale, or if it detects a specific type of item a user is interested in and has instructed it to scan for. For example, a user might be looking for “red shoes” and once programmed as such the device would check any signal it receives with the database provided by manufacturer, merchants, and/or distributors for a signal that identifies “red shoes.” When it detects a signal, the device would notify the user through a mechanism such as a “push” notification, an auditory signal, or another indication means.

The system may store information related to various goods on a separate server, a user device, or in a variety of other places. The system may store data that is related to a specific object such as purchasing information like prices or locations where the object can be purchased, and the system may be configured to allow a buyer to make purchase and shipping requests.

The system may further be configured to direct a user to a storefront of the seller of the goods the user has indicated an interest in, in order to provide additional offerings. Using the above example, a user who has indicated an interest in a specific manufacturer or seller's “red shoes” may be presented with a variety of similar shoes, or clothing articles that complement said shoes, or simply other offerings from the same seller or affiliated sellers.

The system could work in a range of industries, and as the tagging means advance the system can be configured to work in even more industries. For example, smaller tagging means may enable smaller and smaller consumer goods to be tagged using a signal chip. Such signal chips could be chosen from the set including, but not limited to, NFC, RFID, BLE Beacons, or iBeacons. In some embodiments, the system can function utilizing Bluetooth wireless technology to enable the exchanges of data and financial transactions. Some embodiments may utilize other forms of wireless technology, including those not yet developed, or short ranged cellular signals. Some embodiments may make use of RFID or similar signals.

In some embodiments the tagging device could be extremely small and/or there may be numerous tagging devices utilized such that if one fails the others still produce the signal. In other embodiments the tagging device could be much larger depending on the needs of the person or entity tagging the device. For example, a beacon-tag meant for clothing may be sized to fit in the existing clothing tag and be very small, such as the size of a fingernail, or if longer battery life or a stronger signal is needed it could be its own tag and be anywhere from one inch in diameter to three or four (or even larger if needed). For other types of goods the beacon-tag could be even larger, allowing it to accommodate a larger signal source and power supply. Some beacon-tags could be incredibly small, allowing them to fit inside the label on an item of food or inside a compact electronic device.

In some embodiments, the tagging device, or beacon-tag, may be integrated into another component of an article such as an existing clothing tag, or may additionally serve as a component such as a zipper-pull or other functional component. The signal emitter may share space with other components of the article, or may be embedded in its own casing with its own battery for various purposes including, but not limited to, its own protection. Some variations of the system may have the original buyer of a good affix the beacon-tag instead of the manufacturer or seller; in such cases the original buyer may purchase or otherwise obtain a beacon-tag separately and then couple it to the good they want to advertise. The casing and body of the beacon-tag may also be reinforced, regardless of size, in order to protect the components from damage. If, for example, the beacon-tag is coupled to a vehicle it may be necessary to protect it from jostling or other forces, while for beacon-tags coupled to a clothing accessory or electronic device may require protection from sudden impacts.

In some embodiments the tagging device may be configured to couple to existing electrical components such as a battery or power supply to prolong the lifetime of the tagging device. In some embodiments the power supply may be interconnected to an existing battery or power supply in the device rather than be separate, enabling the beacon-tag to continue functioning until the device is no longer operable.

The beacon-tag could be integrated into potentially any good, including, but not limited to, sporting goods, kitchenware, vehicles, electronic devices, food goods, equipment, backpacks, handbags, purses, jewelry, or pet goods. The exact variant of the beacon-tag may differ depending on the configuration of the good it is being embedded in and/or coupled to, to suit the specific needs and features of said good. The beacon-tags are also capable of being discrete, camouflaging as tags or underneath labels, for merchants or manufacturers that wish to hide the tagging.

In some embodiments each beacon-tag broadcasts an identifying signal, though in some variations that signal may be the same among a family of goods, such as but not limited to a stock-keeping unit number for a specific manufacturer, or may be specific to that individual beacon-tag thus identifying a specific copy of a good. In some variations, the system can also be used to locate a person's own goods, with the system notifying a user if an item that has been reported or otherwise designated as “lost” is detected by another device.

Another way of stating the invention is to describe it as a method, wherein it is a method of configuring a beacon-tag to emit a signal which may contain information such as a serial number or a SKU associated with an item to which the beacon-tag is attached. Then a user's device detects the signal and through a software application installed on the device receives information related to the item; in some embodiments the user may have to affirmatively express an interest in an item for information to be provided, or the application may provide a reviewable list of all of the applicable items in signal range of the user's mobile device. The application may communicate with a server in order to retrieve the information about the item. The user may then be able to purchase the item directly from whomever is in possession of it, or may be able to purchase an identical, or similar, item from the manufacturer or a seller through the software application.

In some embodiments of the invention the detection means may be attached or in network communication with an augmented reality device that could be configured to display the location or otherwise highlight the object emitting the signal on an augmented reality screen to a user. The system could be further configured to then provide information about the object in question.

The invention allows for a purchaser of a good to become a seller of a good passively through the identification tag, which will allow others to detect the good that the original purchaser is interested in selling and potentially purchase it from them on the spot or arrange for shipping. In some embodiments a potential buyer can arrange to purchase similar goods to the ones detected instead of buying the exact good. In effect, the wearer of a good becomes seller and/or advertiser of the goods in question, and may be compensated or not by a manufacturer. Additionally, the system enables a manufacturer to sell to parties indirectly without having to engage in the initial offer for sale; instead the beacon-tag directs a purchaser to a location from which they can purchase the item.

Some embodiments of the invention can be described as a system comprising: at least one beacon comprising at least: a signal emitter; a power supply; one or more media operably connected to the signal emitter and configured to instruct the signal emitter to emit at least one signal; at least one buyer device that is communicably linked to an information network, the buyer device comprising at least: one or more media including one or more executable instructions; a signal detection device; at least one processor operatively connected to the one or more media, wherein the at least one processor is configured to execute the one or more executable instructions to perform operations including at least: requesting information from a server over the information network based on the signal received from the at least one beacon; receiving information related to an object in response to the request. The processor may additionally be configured to instruct a graphical user interface or other interface to display information including but not limited to purchasing information to a user, and may further be configured to send a purchasing request to a server or third-party seller.

In other embodiments, the system is a method of indirect transactions between a buyer and a seller, the method comprising the steps of: coupling one or more beacons to an object belonging to a type of objects wherein the one or more beacons are configured to produce one or more signals; having a buyer device detect at least one of the one or more signals produced by the one or more beacons that produces the signal; having a buyer device communicate with at least one server configured to associate the signal with the object the beacon was coupled to; sending the buyer device information related to the type of objects the object belongs to; and allowing the buyer device to initiate a purchase of the object or a copy of the object based on the information provided.

Some embodiments of the invention can be described as a system for indirect transactions between a buyer and a seller, the system comprising: at least one beacon configured to produce at least one signal containing an identifier; an object that is coupled to the at least one beacon; a buyer device configured to be capable of issuing requests and comprising a detector, wherein the detector is configured to detect the at least one signal and further comprises; a server, wherein the server comprises an entry stored in a memory that associates the object with the identifier contained in the signal and with a seller, and an entry stored in a memory that associates the identifier with information associated with the object, and is configured to: determine that the seller is associated with the object based on the identifier detected by the buyer device; provide the information associated with the object or a copy of the object to the buyer device.

### BRIEF DESCRIPTION OF THE DRAWINGS

Embodiments of the present invention are described in detail below with reference to the following drawings:

FIG. 1 is a diagram demonstrating the flow of the system and method, in accordance with an embodiment of the invention;

FIG. 2 is an example of how a beacon-tag might be integrated into a purchasable object, in accordance with an embodiment of the invention;

FIG. 3 is a flow-chart showing how a transaction might occur from a user's perspective, in accordance with an embodiment of the invention;

FIG. 4 is an exploded, isometric perspective view of a beacon-tag that could be affixed to an object such as an article of clothing, in accordance with an embodiment of the invention;

FIG. 5 is an example of the beacon-tag that might be embedded into a purchasable object, in accordance with an embodiment of the invention;

FIG. 6 is a system diagram showing the components of the system and how they interact, in accordance with an embodiment of the invention;

FIG. 7 is an example of the beacon-tag integrated into a motor vehicle, in accordance with an embodiment of the invention;

FIG. 8 is an example of the beacon-tag integrated into a mobile electronic device, in accordance with an embodiment of the invention;

FIG. 9 is an example of the beacon-tag integrated into a piece of furniture such as a table, in accordance with an embodiment of the invention;

FIG. 10 is an example of the beacon-tag integrated into a bottle such as a bottle of wine, in accordance with an embodiment of the invention;

FIG. 11 is an example of the beacon-tag integrated into an accessory clothing item such as a purse, in accordance with an embodiment of the invention;

FIG. 12 is an example of the beacon-tag integrated into the zipper-pull of an article of clothing, in accordance with an embodiment of the invention;

FIG. 13 is an example of a computer network system upon which the system may be implemented, in accordance with an embodiment of the invention; and

FIG. 14 is an example of a computing system upon which the system may be implemented, in accordance with an embodiment of the invention.

### DETAILED DESCRIPTION

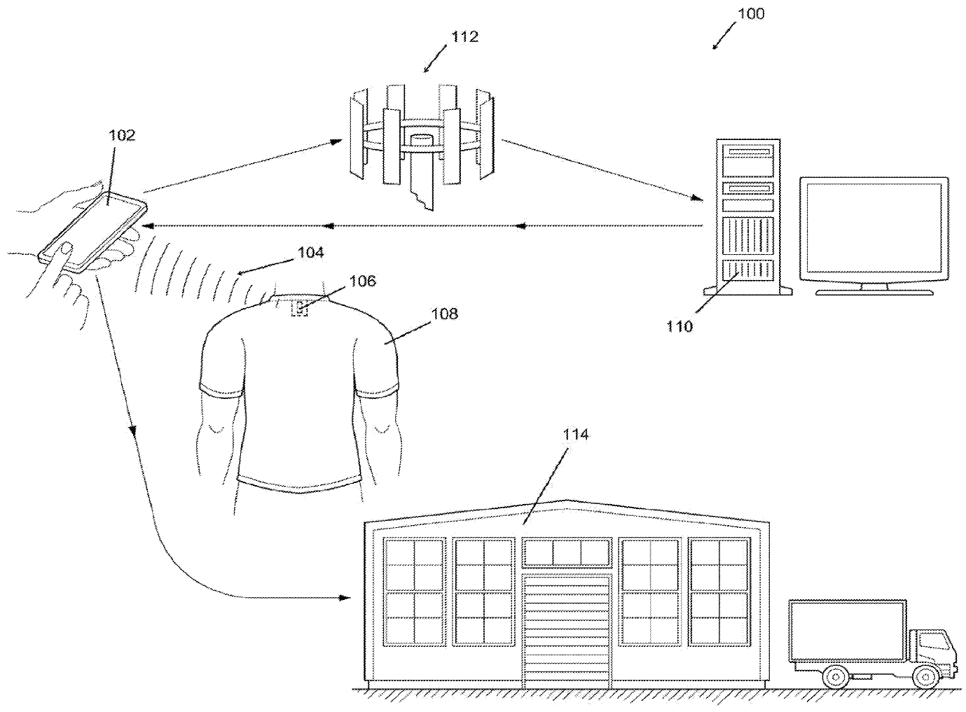

This invention relates generally to a software implemented system for facilitating indirect transactions between customers and sellers. Specific details of certain embodiments of the invention are set forth in the following description and in FIGS. 1-14 to provide a thorough understanding of such embodiments. The present invention may have additional embodiments, may be practiced without one or more of the details described for any particular described embodiment, or may have any detail described for one particular embodiment practiced with any other detail described for another embodiment.

FIG. 1 is a diagram demonstrating the flow of the system and method, in accordance with an embodiment of the invention.

In some embodiments, a system 100 for indirect transactions comprises a user device 102 that receives a signal 104 from a beacon-tag 106 that is coupled to an object 108. The user device 102 then communicates with a server 110 through a network 112 that may comprise a cellular and/or internet network. The server 110 then provides the user device 102 with data related to the object 108, and presents the user device 102 with options for purchasing the good which may be through a merchant, distributor, or manufacturer 114, who can then ship the device to the user of the user device 102 or a third party, or may be configured such that the user can obtain the object 108 from another third party such as a person with the original beacon-tag 106 coupled to object 108 or a copy, or from a third-party merchant or distributor.

In some embodiments, the original object 108 that was emitting the signal 104 detected by the user device 102 can be purchased from the person in possession of the object 108; such as where an article of clothing can be purchased directly. In other embodiments, the system 100 can direct the user of the user device 102 to where a copy of the object 108 can be purchased from a merchant, distributor, or manufacturer 114; or the object 108 can be purchased directly through a software application from the aforementioned parties and shipped to the user or a location of the user's choice.

Some examples of the invention may have the merchant, distributor, or manufacturer 114 place a beacon-tag 106 on the object 108 at the time of production or before putting it out into the marketplace, while in other variants a user can purchase beacon-tags 106 from a third party such as the host of the system 100. Such purchased beacon-tags 106 could then be affixed to objects 108 that the user wishes to sell.

In some embodiments, the user that affixes a beacon-tag 106 to an object 108 may be compensated by a merchant, distributor, or manufacturer 114 for sales that occur as a result of user devices 102 detecting the beacon-tag 106 from that user's object 108 and subsequently make a purchase of copies of said object 108, or review other offerings as a result of that beacon-tag 106.

In one embodiment, an article, such as a clothing article, is tagged with a beacon-tag 106 device, such as, but not limited to, a signal chip that may be embedded into a tag or the fabric itself that broadcasts a signal 104 which contains information such as information associated with the object, such as a unique identification number. The signal 104 may then be detected by a sensor which may be programed or embedded into a user device 102 such as, but not limited to, a mobile phone. A third-party merchant, distributor, or manufacturer 114 or other party can program certain information such as a serial number or other information in a given signal chip, allowing the detector to interpret and display, or fetch from a centralized database, information regarding an object 108 that has a beacon-tag 106 embedded inside of it. Some embodiments may allow another user, utilizing the detector or a software application, to purchase the object 108 that has been tagged directly from the owner, or in other embodiments the system 100 may redirect the user to a manufacturer or distributor from whom they can purchase the same or a similar object 108, or shop for similar items. In some embodiments, a detected identifier may provide a user that is utilizing a smart phone or other user device 102 with display capability with information on the object 108 and a range of merchants, distributors, or manufacturers 114 from whom similar or identical items could be purchased. In some embodiments the invention is comprised of a software application that is integrated into the system 100 and allows display of information detected from the embedded identifiers and/or that the identifier redirects the user to.

For example, in one embodiment of the invention a user would activate their user device 102, in this example a mobile device, which would then actively detect signals 104 in proximity to the user device 102 emitted by a plurality of beacon-tags 106. The user device 102 would then cross-reference the signals 104 received with an online database that associates each signal 104 with a specific object 108. The device would then present the objects 108 associated with the detected signals 104 to the user with information on how to purchase the object 108. If the user were interested in purchasing a specific object 108, the user could indicate that through the user device 102, and may then be able to purchase the specific object 108 from the person who was wearing the object 108 with the beacon-tag 106, or may be able to order an identical or similar object 108 from the merchant, distributor, or manufacturer 114 that ordinarily sells such, or another party along the distribution chain.

The system 100 may also be programmed to allow a user to make additional selections once they have found an object 108 of interest. For example, if a user has identified a pair of “red shoes” from a person wearing a beacon-tagged 106 pair in their vicinity, but the user has wider feet and prefers the shoes in blue. The sellers, or another party, may have the option to allow the user to order the same look and/or style of shoe but, for example, but not limited to, in an alternative color or with special parameters such as, but not limited to, a wider sole, arch supports, or a wider toe. The same general approach could be taken for objects 108 of different types, with a seller allowing a user to potentially order a shirt or other clothing item in a different size (or with additional options depending on the nature of the item in question) or in the case of non-clothing they may allow other qualities to be changed. Some sellers may also allow bundling, or provide suggestions for complementary items within the system.

The signal 104 being broadcast by the beacon-tag 106 may, in some embodiments, be done so periodically or consistently, depending on the needs of the merchant, distributor, or manufacturer 114 or provider of the beacon-tag 106 and relative power constraints of the electronic device.

In some embodiments, the merchant, distributor, or manufacturer 114 of the object 108 that the user has indicated an interest in may offer the option to ship the object 108 to the user directly, or provide instructions on the nearest storefront (which may be owned by the manufacturer or a third party) where the user could purchase the item. This option may appear in the user interface of the software running on the user device 102. Some variants may allow a user to program a passive sensor functionality, such that their user device 102 will passively check any signals it receives from the beacons and notify the user if it detects a signal that meets a certain criteria; such as a specific price, an item being listed as on-sale, or if it detects a specific object 108 type of item a user is interested in and has instructed it scan for. For example, a user might be looking for “red shoes” and once programmed as such the user device 102 would check any signal it receives with the database provided by merchant, distributor, or manufacturer 114 for a signal 104 that identifies “red shoes.” When it detects a signal 104, the user device 102 would notify the user through a mechanism such as a “push” notification, an auditory signal, or another indication means.

The system 100 may further be configured to take a user to a storefront of the seller of the object 108 the user has indicated an interest in, in order to provide additional offerings. Using the above example, a user who has indicated an interest in a specific manufacturer or seller's “red shoes” may be presented with a variety of similar shoes, or clothing articles that complement said shoes, or simply other offerings from the same seller or affiliated sellers.

The system 100 could work in a range of industries, and as the beacon-tagging 106 means advance, the system 100 can be configured to work in even more industries. For example, the smaller the tagging means, such as even smaller, long-life signal chips may enable smaller and smaller consumer goods to be tagged using a signal chip sized beacon-tag 106. Such beacon-tags 106 could be chosen from the set including, but not limited to, NFC, RFID, BLE Beacons, or iBeacons. In some embodiments, the system 100 can function utilizing Bluetooth wireless technology to enable the exchanges of data and financial transactions. In others, the wireless technology may be of another variety, such as a cellular network or over the internet. Some embodiments may utilize other forms of wireless technology, including those not yet developed, or short ranged cellular signals

In some embodiments the beacon-tag 106 could be extremely small and/or there may be numerous tagging devices utilized such that if one fails the others still produce the signal 104. In other embodiments the beacon-tag 106 could be much larger depending on the needs of the person or entity tagging the object 108. For example, a beacon-tag 106 meant for clothing may be sized to fit in the existing clothing tag and be very small, such as the size of a fingernail, or if longer battery life or a stronger signal is needed it could be its own tag and be anywhere from one inch in diameter to three or four (or even larger if needed). For other types objects 108 the beacon-tag 106 could be even larger, allowing it to accommodate a larger signal source and power supply.

In some embodiments, the tagging device, or beacon-tag 106 may be integrated into another component of an object 108 such as an existing clothing tag, or may additionally serve as a component such as a zipper-pull or other functional component. The beacon-tag 106 may share space with other components of the object 108, or may be embedded in its own casing with its own battery for various purposes including its own protection. Some variations of the system may have the original buyer of a good affix the beacon-tag 106 instead of the manufacturer or seller; in such cases the original buyer may purchase or otherwise obtain a beacon-tag 106 separately and then couple it to the good they want to advertise.

In some embodiments the beacon-tag 106 may be configured to couple to existing electrical components such as a battery or power supply to prolong the lifetime of the tagging device. In some embodiments the power supply may be interconnected to an existing battery or power supply in the object 108 rather than be separate, enabling the beacon-tag 106 to continue functioning until the object 108 is no longer operable.

Another way of stating the invention is to describe it as a method, wherein it is a method of configuring a beacon-tag 106 to emit a signal 104 which may contain information such as a serial number or a stock-keeping unit number associated with an object 108 to which the beacon-tag 106 is attached. Then a user's device 102 detects the signal and through a software application installed on the user device 102 receives information related to the object 108; in some embodiments the user may have to affirmatively express an interest in an object 108 for information to be provided, or the application may provide a reviewable list of all of the applicable objects 108 in signal range of the user's device 102. The application may communicate with a server in order to retrieve the information about the object 108. The user may then be able to purchase the object 108 directly from whomever is in possession of it, or may be able to purchase an identical, or similar, object 108 from the merchant, distributor, or manufacturer 114 through the software application.

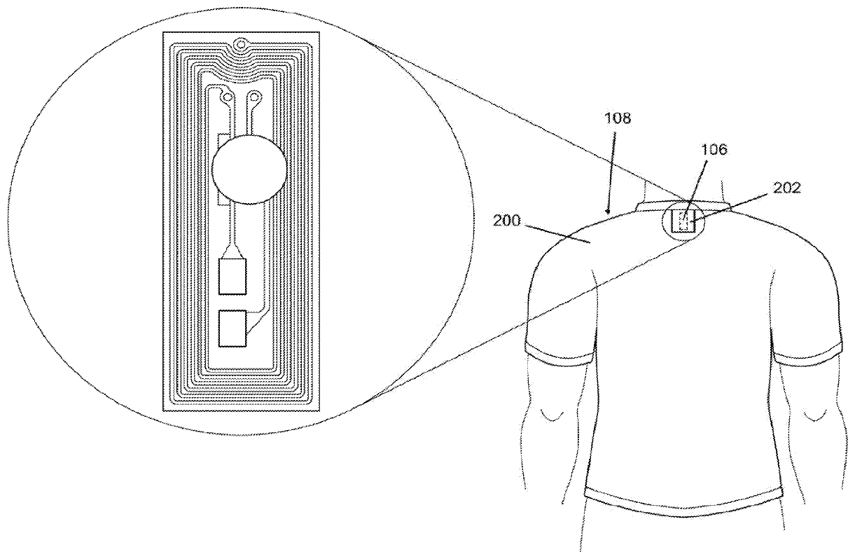

FIG. 2 is an example of how a beacon-tag might be integrated into a purchasable object, in accordance with an embodiment of the invention.

In some embodiments, the beacon-tag 106 might be integrated into an object 108 such as an article 200 of clothing by sewing it into the tag 202 of said article 200. In such arrangements the beacon-tag 106 may be very small, sufficient to fit inside said tag. However, in other embodiments the beacon-tag 106 may be sewn into another area of an article 200 such as, but not limited to, the hem, sleeve, or collar of an article 200 of clothing.

The system could work in a range of industries, and as the beacon-tagging 106 means advance, the system can be configured to work in even more industries. For example, smaller, long-life signal chips may enable smaller and smaller consumer goods to be tagged using beacon-tags 106; some embodiments may be smaller than human fingernails or as thin as paper. Such beacon-tags 106 could be chosen from the set including, but not limited to, NFC, RFID, BLE Beacons, or iBeacons. In some embodiments, the system can function utilizing Bluetooth wireless technology to enable the exchanges of data and financial transactions. In others, the wireless technology may be of another variety, such as a cellular network or over the internet.

In some embodiments the beacon-tag 106 could be extremely small and/or there may be numerous tagging devices utilized such that if one fails the others still produce the signal. In other embodiments the beacon-tag 106 could be much larger depending on the needs of the person or entity tagging the device. For example, a beacon-tag 106 meant for clothing may be sized to fit in the existing clothing tag and be very small, such as the size of a fingernail, or if longer battery life or a stronger signal is needed it could be its own beacon-tag 106 and be anywhere from one inch in diameter to three or four (or even larger if needed). For other types of goods the beacon-tag 106 could be even larger, allowing it to accommodate a larger signal source and power supply.

In some embodiments, the tagging device, or beacon-tag 106 may be integrated into another component of an article 200 such as an existing tag 202, or may additionally serve as a component such as a zipper-pull or other functional component. The beacon-tag 106 may share space with other components of the article, or may be embedded in its own casing with its own battery for various purposes including its own protection. Some variations of the system may have the original buyer of a good affix the beacon-tag 106 instead of the manufacturer or seller; in such cases the original buyer may purchase or otherwise obtain a beacon-tag 106 separately and then couple it to the good they want to advertise.

In some embodiments the beacon-tag 106 may be configured to couple to existing electrical components such as a battery or power supply to prolong the lifetime of the tagging device. In some embodiments the power supply may be interconnected to an existing battery or power supply in the device rather than be separate, enabling the beacon-tag 106 to continue functioning until the object 108 is no longer operable.

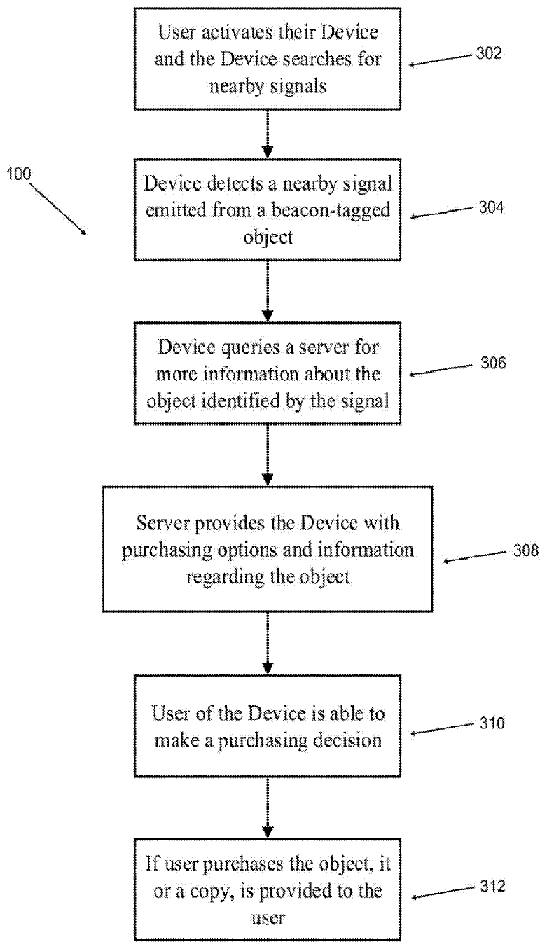

FIG. 3 is a flow-chart showing how a transaction might occur from a user's perspective, in accordance with an embodiment of the invention.

When using the system 100, a user would first activate the system 100 on their device and the device would search for nearby signals emitted from beacon-tags as shown in step 302. The device then detects a nearby signal emitted from a beacon-tagged object, as in step 304. Following that, the device queries a server hosted by the system for more information on the object associated with the signal received, as in step 306.

The server then sends information related to the object to the user device as demonstrated in step 308. In step 310 the user of the user device is then able to make purchasing decisions based on the information sent in step 308. Depending on the decision made, the user might be provided the object the beacon-tag was attached to, or may be provided with an identical or similar copy of the object as described in step 312.

Another way of stating the invention is to describe it as a method, wherein it is a method of configuring a beacon-tag to emit a signal which may contain information such as a serial number or a SKU associated with an object to which the beacon-tag is attached. Then a user's device detects the signal and through a software application installed on the user device receives information related to the object; in some embodiments the user may have to affirmatively express an interest in an object for information to be provided, or the application may provide a reviewable list of all of the applicable objects in signal range of the user's device. The application may communicate with a server in order to retrieve the information about the object. The user may then be able to purchase the object directly from whomever is in possession of it, or may be able to purchase an identical, or similar, object from the merchant, distributor, or manufacturer through the software application.

For example, in one embodiment of the invention a user would activate their user device, in this example a mobile device, which would then actively detect signals in proximity to the user device emitted by a plurality of beacon-tags. The user device would then cross-reference the signals received with an online database that associates each signal with a specific good. The device would then present the goods associated with the detected signals to the user with information on how to purchase the object. If the user were interested in purchasing a specific object, the user could indicate that through the device, and may then be able to purchase the specific object from the person who was wearing the object with the beacon-tag, or may be able to order an identical or similar object from the merchant, distributor, or manufacturer that ordinarily sells such, or another party along the distribution chain.

The system may also be programmed to allow a user to make additional selections once they have found an object of interest. For example, if a user has identified a pair of “red shoes” from a person wearing a beacon-tagged pair in their vicinity, but the user has wider feet and prefers the shoes in blue. The sellers, or another party, may have the option to allow the user to order the same look and/or style of shoe but, for example, but not limited to, in an alternative color or with special parameters such as, but not limited to, a wider sole, arch supports, or a wider toe. The same general approach could be taken for goods of different types, with a seller allowing a user to potentially order a shirt or other clothing item in a different size (or with additional options depending on the nature of the item in question) or in the case of non-clothing they may allow other qualities to be changed. Some sellers may also allow bundling, or provide suggestions for complementary items within the system.

The signal being broadcast by the beacon-tag means or beacon-tag may, in some embodiments, be done so periodically or consistently, depending on the needs of the manufacturer or provider of the beacon-tag and relative power constraints of the electronic device.

In some embodiments, the manufacturer of the object that the user has indicated an interest in may offer the option to ship the object to the user directly, or provide instructions on the nearest storefront (which may be owned by the manufacturer or a third party) where the user could purchase the item. This option may appear in the user interface of the software running on the user device. Some variants may allow a user to program a passive sensor functionality, such that their user device will passively check any signals it receives from the beacons and notify the user if it detects a signal that meets a certain criteria; such as a specific price, an item being listed as on-sale, or if it detects a specific object type of item a user is interested in and has instructed it to go look. For example, a user might be looking for “red shoes” and once programmed as such the user device would check any signal it receives with the database provided by manufacturer, merchants, and/or distributors for a signal that identifies “red shoes.” When it detects a signal, the user device would notify the user through a mechanism such as a “push” notification, an auditory signal, or another indication means.

The system may further be configured to take a user to a storefront of the seller of the object the user has indicated an interest in, in order to provide additional offerings. Using the above example, a user who has indicated an interest in a specific manufacturer or seller's “red shoes” may be presented with a variety of similar shoes, or clothing articles that complement said shoes, or simply other offerings from the same seller or affiliated sellers.

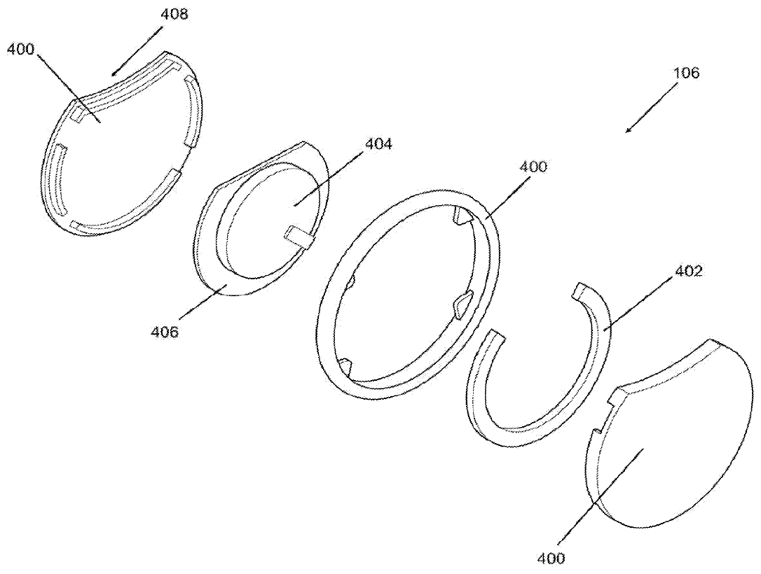

FIG. 4 is an exploded view of a beacon-tag that could be affixed to an object such as an article of clothing.

Some variants of the beacon-tag 106 are comprised of an outer-casing 400, which may or may not be divisible into multiple pieces, a signal emitter 402, a power supply 404, and a storage media 406 for signal information. As depicted in FIG. 4 the beacon-tag 106 may include a notch 408 allowing it to be affixed to an object. Variants of the beacon-tag 106 may involve the beacon-tag 106 being affixed to an article 200 of clothing such as a jacket through a functional or semi-functional component thereof, such as, but not limited to, a zipper-pull or drawstring.

The notch 408 may be a notch, or may be a carabiner, hook and loop, key-ring, latch, or similar mechanism operable to attach the beacon-tag 106 to the object or article that it is being attached to.

In some embodiments, the beacon-tag 106 might be integrated into an object such as an article of clothing by sewing it into the tag of said article. In such arrangements the beacon-tag 106 may be very small, sufficient to fit inside said tag. However, in other embodiments the beacon-tag 106 may be sewn into another area of an article such as, but not limited to, the hem, sleeve, or collar of an article of clothing.

The system could work in a range of industries, and as the beacon-tagging 106 means advance, the system can be configured to work in even more industries. For example smaller, long-life signal chips may enable smaller and smaller consumer goods to be tagged using a signal chip sized beacon-tag 106. Such beacon-tags 106 could be chosen from the set including, but not limited to, NFC, RFID, BLE Beacons, or iBeacons. In some embodiments, the system can function utilizing Bluetooth wireless technology to enable the exchanges of data and financial transactions. In others, the wireless technology may be of another variety, such as a cellular network or over the internet.

In some embodiments the beacon-tag 106 could be extremely small and/or there may be numerous tagging devices utilized such that if one fails the others still produce the signal. In other embodiments the beacon-tag 106 could be much larger depending on the needs of the person or entity tagging the device. For example, a beacon-tag 106 meant for clothing may be sized to fit in the existing clothing tag and be very small, such as the size of a fingernail, or if longer battery life or a stronger signal 104 is needed it could be its own beacon-tag 106 and be anywhere from 1 inch in diameter to 3 or 4 (or even larger if needed). For other types of goods the beacon-tag 106 could be even larger, allowing it to accommodate a larger signal source and power supply.

In some embodiments, the tagging device, or beacon-tag 106 may be integrated into another component of an article such as an existing clothing tag, or may additionally serve as a component such as a zipper-pull or other functional component. The beacon-tag 106 may share space with other components of the article, or may be embedded in its own casing with its own battery for various purposes including its own protection. Some variations of the system may have the original buyer of a good affix the beacon-tag 106 instead of the manufacturer or seller; in such cases the original buyer may purchase or otherwise obtain a beacon-tag 106 separately and then couple it to the good they want to advertise.

In some embodiments the beacon-tag 106 may be configured to couple to existing electrical components such as a battery or power supply to prolong the lifetime of the tagging device. In some embodiments the power supply may be interconnected to an existing battery or power supply in the device rather than be separate, enabling the beacon-tag 106 to continue functioning until the object is no longer operable.

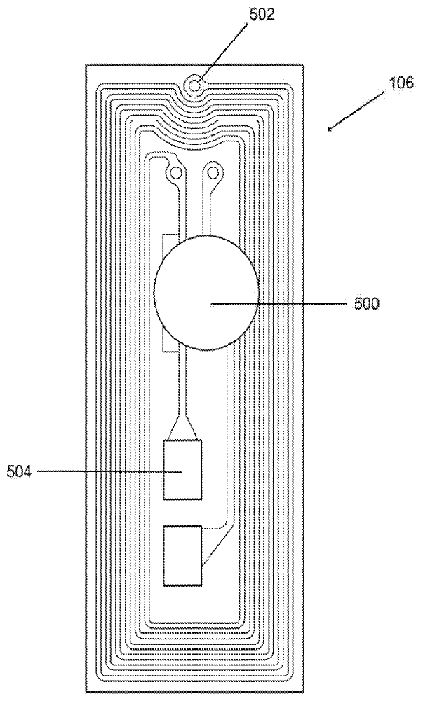

FIG. 5 is an example of the beacon-tag chip that might be embedded into a purchasable object, in accordance with an embodiment of the invention.

Some variants of the invention may involve a small or micro-sized beacon-tag 106 assembly designed to comfortably fit in the tag of an article of clothing or discretely inside another object. In such cases the beacon-tag 106 chip would comprise a power supply 500, an antenna 502, and the electronic media 504 that contain the signal data.

In some embodiments, the beacon-tag 106 might be integrated into an object such as an article of clothing by sewing it into the tag of said article. In such arrangements the beacon-tag may be very small, sufficient to fit inside said tag. However, in other embodiments the beacon-tag may be sewn into another area of an article such as, but not limited to, the hem, sleeve, or collar of an article of clothing.

The system could work in a range of industries, and as the beacon-tagging 106 means advance, the system can be configured to work in even more industries. For example, the smaller the tagging means, such as even smaller, long-life signal chips may enable smaller and smaller consumer goods to be tagged using a signal chip sized beacon-tag 106. Such beacon-tags 106 could be chosen from the set including, but not limited to, NFC, RFID, BLE Beacons, or iBeacons. In some embodiments, the system can function utilizing Bluetooth wireless technology to enable the exchanges of data and financial transactions. In others, the wireless technology may be of another variety, such as a cellular network or over the internet.

In some embodiments the beacon-tag 106 could be extremely small and/or there may be numerous tagging devices utilized such that if one fails the others still produce the signal. In other embodiments the beacon-tag 106 could be much larger depending on the needs of the person or entity tagging the device. For example, a beacon-tag 106 meant for clothing may be sized to fit in the existing clothing tag and be very small, such as the size of a fingernail, or if longer battery life or a stronger signal is needed it could be its own beacon-tag 106 and be anywhere from one inch in diameter to three or four (or even larger if needed). For other types of goods the beacon-tag 106 could be even larger, allowing it to accommodate a larger signal source and power supply.

In some embodiments, the tagging device, or beacon-tag 106 may be integrated into another component of an article such as an existing clothing tag, or may additionally serve as a component such as a zipper-pull or other functional component. The beacon-tag 106 may share space with other components of the article, or may be embedded in its own casing with its own battery for various purposes including its own protection. Some variations of the system may have the original buyer of a good affix the beacon-tag 106 instead of the manufacturer or seller; in such cases the original buyer may purchase or otherwise obtain a beacon-tag 106 separately and then couple it to the good they want to advertise.

In some embodiments the beacon-tag 106 may be configured to couple to existing electrical components such as a battery or power supply to prolong the lifetime of the tagging device. In some embodiments the power supply may be interconnected to an existing battery or power supply in the device rather than be separate, enabling the beacon-tag 106 to continue functioning until the object is no longer operable.

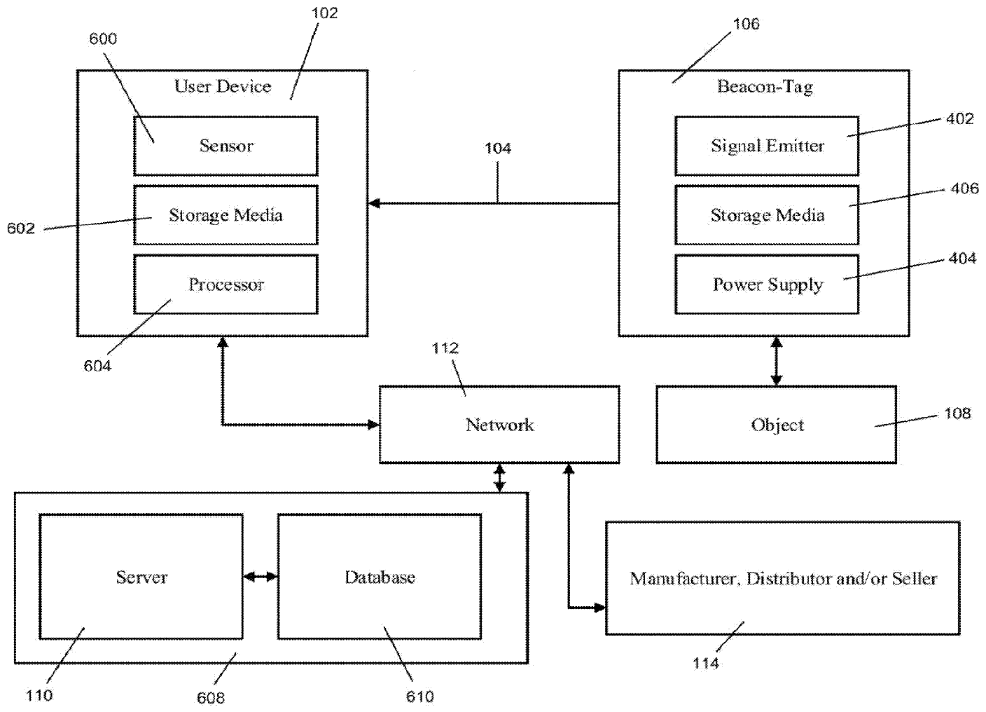

FIG. 6 is a system diagram showing the components of the system and how they interact, in accordance with an embodiment of the invention.

The system 100 described herein can be demonstrated in the diagram of FIG. 6. A user device 102 comprising at least a sensor 600, a storage media 602, and a processor 604 and is configured to be able to interact with a network 112, such as the internet, detects a signal 104 from a beacon-tag 106. The beacon-tag 106 comprises at least a signal emitter 402, a storage media 406, and a power supply 404. The beacon-tag 106 is then coupled to an object 108, such as an article of clothing, accessory, or device, either removably or permanently. The sensor 600 of the user device 102 detects the signal 104 emitted by the beacon-tag 106. The processor 604 on the user device is able to execute instructions whereby it connects to a host system 608 which is comprised of a server 110 which is in communication with a database 610 that stores information related to the object 108. The host system 608 uses the server 110 to relay the information related to the object 108 to the user device 102 over the network 112. The merchant, distributor, or manufacturer 114 is able to provide the information related to the object 108 to the host system 608 over the network 112 or a second network. Once the object 108 has been identified to the user device 102 the system can arrange a transaction between the user device 102 and the merchant, distributor, or manufacturer 114 over the network 112.

The power supply 404 may be a battery or similar power storage medium; it may be configured to attach to a power source intrinsic to the object 108, such as, but not limited to, a mobile device's existing battery; or may be configured with an alternative power supply such as a solar panel or human bio-energy harvester; or some configurations may combine multiple forms of the above.

In some embodiments, the signal emitter 402 and storage media 406 may be combined into a single structure that draws power from the power supply 404 and emits one or more signals 104.

The database 610 can be, but is not limited to, a server, a single computer, or a cloud service, or a yet to be developed method of remotely storing information.

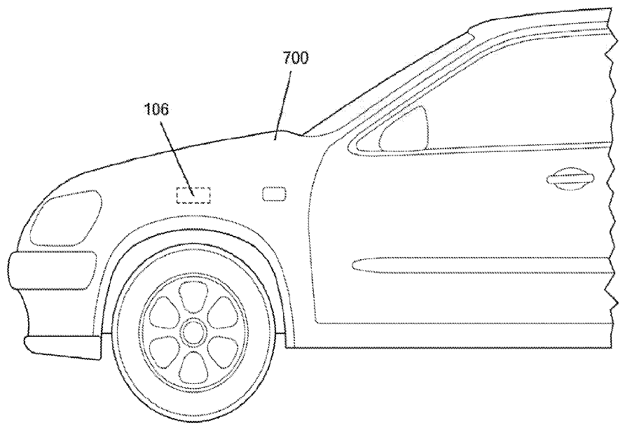

FIG. 7 is an example of the beacon-tag integrated into a motor vehicle, in accordance with an embodiment of the invention.

The beacon-tag 106 component of the system can be applied to a good such as a vehicle 700, which may or may not be motorized. In such situations the beacon-tag 106 could be much larger than in other variations and integrated anywhere into the chassis or body of the vehicle 700. In some embodiments, the beacon-tag 106 might be directly connected to the battery or other power system of the vehicle 700, while in others it may have its own battery, and in other variants it may have its own battery and be 670 integrated into the power supply of the vehicle 700. In some embodiments the beacon-tag 106 may also be reinforced to prevent damage due to adverse conditions experienced by the vehicle 700. For example, the beacon-tag 106 could be integrated into a bicycle, car, or wheelchair.

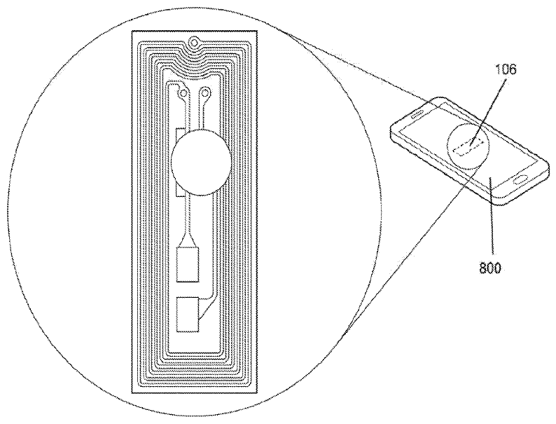

FIG. 8 is an example of the beacon-tag integrated into a mobile electronic device, in accordance with an embodiment of the invention.

In some variations the beacon-tag 106 component of the system can be integrated into an electronic device, including, but not limited to, a mobile electronic device 800, cellular phone, personal GPS, or other electronic item. In some embodiments, the beacon-tag 106 might be directly connected to the battery or other power system of the mobile electronic device 800, while in others it may have its own battery, and in other variants it may have its own battery and be integrated into the power supply of the mobile electronic device 800. In some embodiments the beacon-tag 106 may also be reinforced to prevent damage due to wear and tear on the device or sudden impacts from the device being dropped.

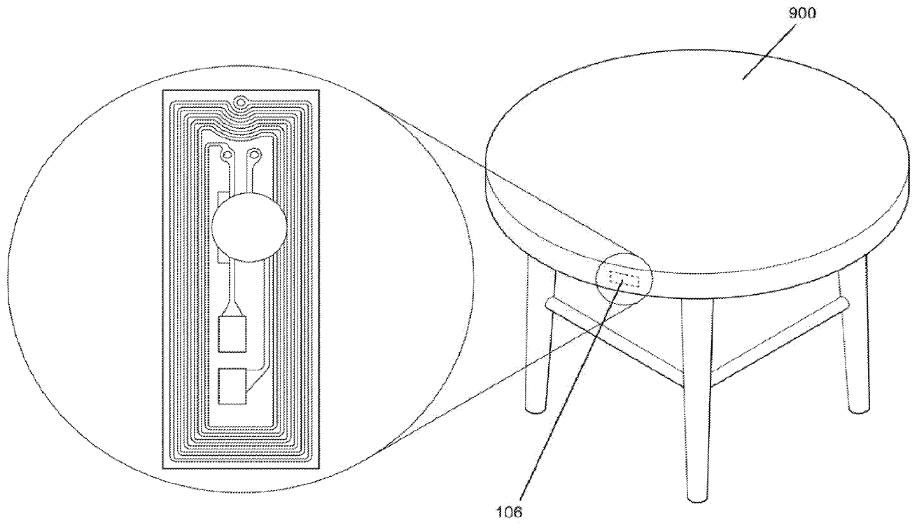

FIG. 9 is an example of the beacon-tag integrated into a piece of furniture such as a table, in accordance with an embodiment of the invention.

The beacon-tag 106 may also be integrated into a piece of furniture 900 by storing it, for example, but not limited to, the hollow of a table or chair leg, or inside a couch or loveseat frame. Such pieces of furniture 900 could include, but are not limited to, tables, lamps, couches, beds, loveseats, chairs, or any other structure. For examples that have their own integrated power system, such as a lamp, the beacon-tag 106 might be directly connected to the battery or other power system of the furniture item, while in others it may have its own battery, and in other variants it may have its own battery and be integrated into the power supply of the furniture 900 item. When stored in furniture 900, it could be in a hollow, or externally located place, depending on the needs of the party placing the beacon-tag 106.

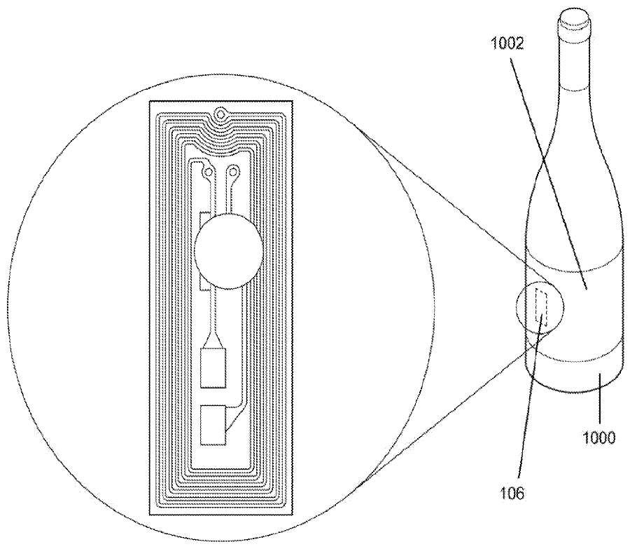

FIG. 10 is an example of the beacon-tag integrated into in a bottle such as a bottle of wine, in accordance with an embodiment of the invention.

The beacon-tag 106 could alternatively be placed inside the packaging of a food item such as a bottle 1000 of wine, or in the case of a particularly small beacon-tag 106, could be integrated into the label 1002 of a good as demonstrated in FIG. 10.

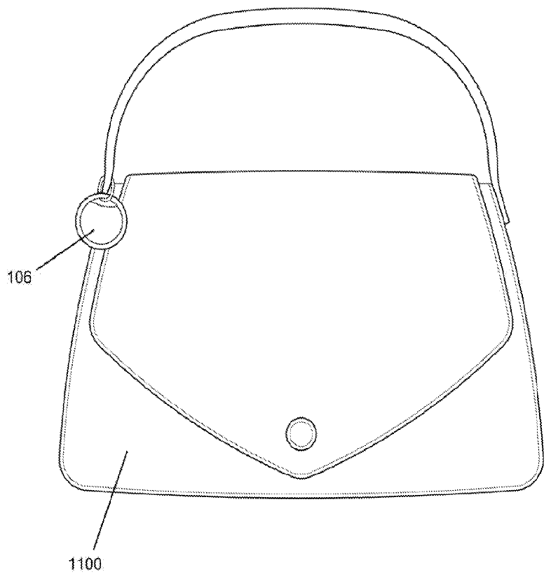

FIG. 11 is an example of the beacon-tag integrated into an accessory clothing item such as a purse, in accordance with an embodiment of the invention.

Some variations of the invention may incorporate the beacon-tag 106 into an accessory item 1100 such as a purse, handbag, shoe, necklace, earring, other jewelry, backpack, or potentially any future developed good. In such cases, like in other embodiments, the beacon-tag 106 could have its own internal power supply, be connected to an existing power supply intrinsic to the good, or a combination of the two. The beacon-tag 106 could also be integrated into kitchenware, sporting goods, art, or virtually any other good.

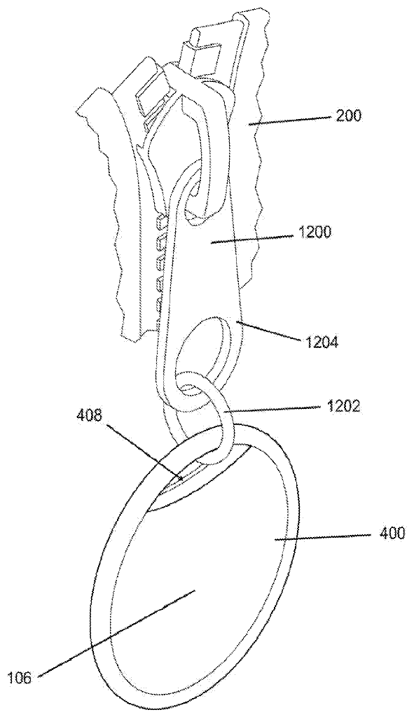

FIG. 12 is an example of the beacon-tag integrated into the zipper-pull of an article of clothing.

Some variations of the invention may incorporate the beacon-tag 106 into a functional or semi-functional component of an item. In such cases the notch 408 can be coupled to, for example, but not limited to, a ring 1202 or the zipper 1204 of the zipper-pull 1200. Some variants of the beacon-tag 106 are comprised of an outer-casing 400, which may or may not be divisible into multiple pieces, a signal emitter, a power supply, and a storage media for signal information. The beacon-tag 106 may include a notch 408 allowing it to be affixed to an object. Variants of the beacon-tag 106 may involve the beacon-tag 106 being affixed to an article 200 of clothing such as a jacket through a functional or semi-functional component thereof, such as, but not limited to, a zipper-pull or drawstring.

The notch 408 may be a notch, or may be a carabiner, hook and loop, key-ring, latch, or similar mechanism operable to attach the beacon-tag 106 to the object or article 200 that it is being attached to. The beacon-tag 106 may come in a variety of shapes depending on the design aesthetic of the manufacturer and other needs, but could come in such shapes as, but not limited to, circular, square, rectangular, or some other polygonal shape and may be substantially flat or may not be, again depending on the needs of the manufacturer. For example, the beacon-tag 106 could be cubic in shape, or spherical, or a pyramid shape.

In some embodiments, the beacon-tag 106 might be integrated into an object such as an article 200 of clothing by sewing it into the tag of said article 200. In such arrangements the beacon-tag 106 may be very small, sufficient to fit inside said tag. However, in other embodiments the beacon-tag 106 may be sewn into another area of an article such as, but not limited to, the hem, sleeve, or collar of an article 200 of clothing.

In some embodiments, the tagging device, or beacon-tag 106 may be integrated into another component of an article 200 such as an existing clothing tag, or may additionally serve as a component such as a zipper-pull or other functional component. The beacon-tag 106 may share space with other components of the article 200, or may be embedded in its own casing with its own battery for various purposes including its own protection. Some variations of the system may have the original buyer of a good affix the beacon-tag 106 instead of the manufacturer or seller; in such cases the original buyer may purchase or otherwise obtain a beacon-tag 106 separately and then couple it to the good they want to advertise.

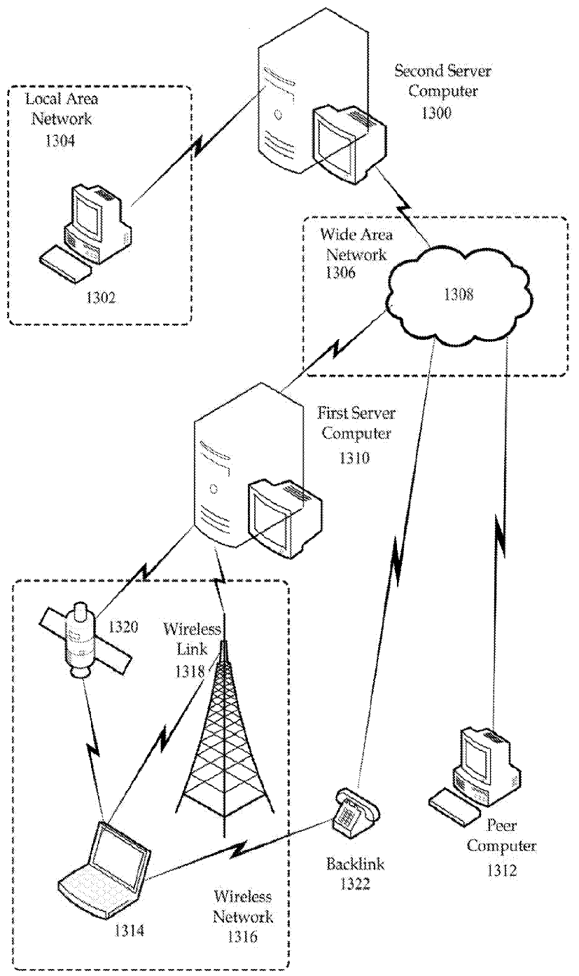

FIG. 13 is an example of a computer network system upon which the system may be implemented.

Computer 1300 may be a server computer coupled to a user's computer 1302 or other device through a conventionally constructed local area network 1304.

In the local area network the user's computer 1302 is typically part of the local area network 1304 which may include a plurality conventional computers (not shown) and conventional peripheral equipment (not shown) coupled together utilizing topologies (token, star and the like) and switching equipment known to those skilled in the art. Those skilled in the art will realize that other processor equipped devices such as cellular telephones, PDAs, tablets printers, appliances and the like may be coupled to the internet utilizing conventional techniques known to those skilled in the art.

A typical local area network 1304 may include a conventionally constructed ISP network in which a number or plurality of subscribers utilize telephone dial up, ISDN, DSL, cellular telephone, cable modem, or the like connections to couple their computer to one or more server computers 1300 that provide a connection to the world wide web 1306 via the internet 1308.

An example wide area network or world wide web 1306 is conventionally constructed and may include the internet 1308 or equivalent coupling methods for providing a wide area network. As shown a conventionally constructed first server computer 1310 is coupled to conventionally constructed second server computer 1300 through a conventionally constructed internet connection to the world wide web 1308.

In a peer to peer network a Peer computer 1312 is conventionally constructed to couple to the internet 1308 utilizing peer to peer network technology. Peer computer 1312 may couple to a plurality of similarly connected peer computers in a peer to peer network (not shown), or to other computers 1314, 1302 that are part of conventionally constructed networks 1304, 1306.

In a conventional wireless network 1316 a conventionally constructed computer 1314 is coupled to the internet 1308 via a conventionally constructed wireless link 1318. The wireless link may include cellular, and satellite technology 1320 to provide the link. Such a wireless network may include a conventionally constructed first server computer 1310, typically provided to manage connections to a wide area network such as the internet.

A conventionally constructed back link may be provided to efficiently provide an additional channel to couple to the internet. For example in situations where communication is one way in nature, the back link 1322 may provide communications in the opposite direction. Those skilled in the art will realize that back links may equivalently be provided by cellular telephones, tablets, cordless telephones, paging devices and the like.

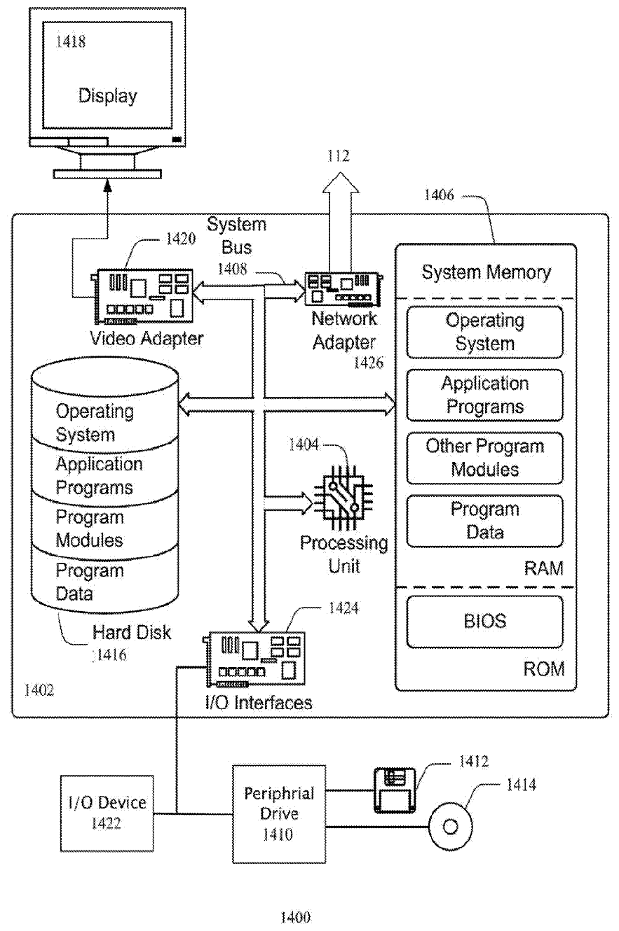

FIG. 14 is an example of a computing system upon which the system may be implemented.

Exemplary computing environment 1400 is only one example of a computing system and is not intended to limit the examples described in this application to this particular computing environment.

For example the computing environment 1400 can be implemented with numerous other general purpose or special purpose computing system configurations. Examples of well-known computing systems, may include, but are not limited to, personal computers, hand-held or laptop devices, tablets, microprocessor-based systems, multiprocessor systems, cellular telephones, PDAs, and the like.

The computer 1400 includes a general-purpose computing system in the form of a computing device 1402. The components of computing device 1402 can include one or more processors (including CPUs, GPUs, microprocessors and the like) 1404, a system memory 1406, and a system bus 1408 that couples the various system components. Processor 1404 processes various computer executable instructions, including those to implement the system and to control the operation of computing device 1402 and to communicate with other electronic and computing devices (not shown). The system bus 1408 represents any number of several types of bus structures, including a memory bus or memory controller, a peripheral bus, an accelerated graphics port, and a processor or local bus using any of a variety of bus architectures.

The system memory 1406 includes computer-readable media in the form of volatile memory, such as random access memory (RAM), and/or non-volatile memory, such as read only memory (ROM). A basic input/output system (BIOS) is stored in ROM. RAM typically contains data and/or program modules that are immediately accessible to and/or presently operated on by one or more of the processors 1404.

Mass storage devices 1410 may be coupled to the computing device 1402 or incorporated into the computing device by coupling to the buss. Such mass storage devices 1410 may include a magnetic disk drive which reads from and writes to a removable, non-volatile magnetic disk (e.g., a “floppy disk”) 1412, or an optical disk drive that reads from and/or writes to a removable, non-volatile optical disk such as a CD-ROM or the like 1414. Computer readable media 1412, 1414 typically embody computer readable instructions, data structures, program modules and the like supplied on floppy disks, CDs, portable memory sticks and the like.

Any number of program modules can be stored on the hard disk 1416, Mass storage device 1410, ROM and/or RAM 1406, including by way of example, an operating system, one or more application programs, other program modules, and program data. Each of such operating system, application programs, other program modules and program data (or some combination thereof) may include an embodiment of the systems and methods described herein.

A display device 1418 can be connected to the system bus 1408 via an interface, such as a video adapter 1420. A user can interface with computing device via any number of different input devices 1422 such as a keyboard, pointing device, joystick, game pad, serial port, and/or the like. These and other input devices are connected to the processors 1404 via input/output interfaces 1424 that are coupled to the system bus 1408, but may be connected by other interface and bus structures, such as a parallel port, game port, and/or a universal serial bus (USB).

Computing device 1400 can operate in a networked environment using connections to one or more remote computers through one or more local area networks (LANs), wide area networks (WANs) and the like. The computing device 1402 is connected to a network 112 via a network adapter 1426 or alternatively by a modem, DSL, ISDN interface or the like.

The functionalities described herein are not envisioned to be tied to any one communication protocol, programming language or the like, and may be implemented in any convenient form of coding, computer language or the like where called for to implement a particular function in the system.

Those skilled in the art will realize that the process sequences described above may be equivalently performed in any order to achieve a desired result. Also, sub-processes may typically be omitted as desired without taking away from the overall functionality of the processes described above.

While the above example of a computing environment is one possible implementation, those skilled in the art could also attempt to implement the present invention in nearly any environment capable of implementing a computer, such as in a suitably programmed video game or utilizing a mechanical implementation. For example, practitioners have created virtual “computers” in popular sandbox video games such as Minecraft, and, given the proper tools, could implement this invention in such a game, or in other media.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or distributivity process by executing some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Accordingly, the scope of the invention is not limited by the disclosure of these preferred and alternate embodiments. Instead, the invention should be determined by reference to the claims that follow.

1. A system for indirect transactions between a buyer and a seller, the system comprising:
at least one beacon configured to produce at least one signal and is configured to be removably couplable;
an object that is removably coupled to the at least one beacon;
a buyer device configured to be capable of issuing requests, wherein the buyer device is not coupled to the at least one beacon., and comprising a detector, wherein the detector is configured to detect the at least one signal and further comprises, and the detector is irremovably integrated into the buyer device;
a server, wherein the server comprises an entry stored in a memory that associates the object with the signal and with a seller, and an entry stored in a memory that associates the signal with information associated with the object, and is configured to:
determine that the seller is associated with the object based on the identifier detected by the buyer device;
provide the information associated with the object or a copy of the object to the buyer device.

2. The system of claim 1, wherein the buyer device is a mobile cell phone.

3. The system of claim 1, wherein the at least one beacon is an RFID chip.

4. The system of claim 3, wherein the signal is an RFID signal.

5. The system of claim 4, wherein the purchasing information comprises a price and a mechanism to purchase the object.

6. (canceled)

7. The system of claim 4, wherein the purchasing information comprises a price and a location where the object can he purchased.

8. The system of claim 5, wherein the server is further configured to receive and process a purchase request from the buyer device.

9. The system of claim 8, wherein the server is further configured to provide the purchase request from the buyer device to the seller, and provide the seller with the option to accept or decline the purchase.

10. The system of chum 9, wherein. the server is further configured to provide methods for the seller to provide the object or a copy of the object to the buyer to he selected by the buyer or seller.

11. (canceled)

12. The system of claim 11, wherein the server is further configured to arrange for delivery of a copy of the object to the buyer if the seller accepts the purchase of the object or a copy of the object.

13. The system of claim wherein the object is coupled to the at least one beacon by a seller that owns the original object.

14. (canceled)

15. The system of claim 1, wherein the identifier is specific to a third-party seller, the object, or the manufacturer.

16. The system of claim 1, wherein the beacon is affixed to a functional component of the object.

17. The system of claim 1, wherein the beacon is integrated into an existing power supply of the object.

18 .A system comprising:
at least one beacon comprising at least:
a signal emitter;
a power supply;
one or more media operably connected to the signal emitter and configured to instruct the signal emitter to emit at least one signal;
at least one buyer device that is communicably linked to an information network the buyer device comprising at least:
one or more media including one or more executable instructions;
a signal detection device;
at least one processor operatively connected to the one or more media, wherein the at least one processor is configured to execute the one or more executable instructions to perform operations including at least:
requesting information from a server over the information network based on the signal received from the at least one beacon;
receiving information related to an object in response to the request.

19. The system of claim 18, wherein the at least one processor is additionally configured to execute the one or more executable instructions to perform operations including at least
instructing a graphical user interface to display purchasing information to a user; and
transmitting purchase request from a user to a third-party seller.

20. A method of indirect transactions between a buyer and a seller, the method comprising the steps of:
coupling one or more beacons to an object belonging to a type of objects wherein the one or more beacons are configured to produce one or more signals;
having a buyer device detect at least one of the one or more signals produced by the one or more beacons that produces the signal;
having a buyer device communicate with at least one server configured to associate the signal with the object the beacon was coupled to;
sending the buyer device information related to the type of objects the object belongs to; and
allowing the buyer device to initiate a purchase of the object or a copy of the object based on the information provided.

21. The system of claim 4, wherein the at least one beacon produces the at least one signal on a periodic basis.

22. The system of claim 21 wherein the detector is further configured to detect the at least one signal when a specific software application is opened.

23. The system of claim 21, wherein the detector is further configured to passive detect the at least one signal and notify a user of the buyer device upon detection.
